(19) United States
(12) Patent Application Publication
(10) Pub. No.: US 2018/0163766 A1
(43) Pub. Date: Jun. 14, 2018

(54) BLIND BOLT FASTENER WITH EMBOSSMENTS

(71) Applicant: ARCONIC INC., Pittsburgh, PA (US)

(72) Inventors: Luke Haylock, Culver City, CA (US); Wudhidham Prachumsri, Torrance, CA (US); Curtis Lea, Oro Valley, AZ (US)

(73) Assignee: ARCONIC INC., Pittsburgh, PA (US)

(21) Appl. No.: 15/831,647

(22) Filed: Dec. 5, 2017

Related U.S. Application Data
(60) Provisional application No. 62/433,466, filed on Dec. 13, 2016.

(51) Int. Cl. F16B 21/20

(52) U.S. Cl. CPC F16B 21/20

(57) ABSTRACT

A fastener including a core bolt and a sleeve adapted to receive the core bolt. The sleeve includes an elongated portion and a head including a first, outer surface and a plurality of embossments located on and extending from the first surface. The plurality of embossments is adapted to mate with and be engaged by corresponding debossments of a fastener installation tool. The embossments react installation torque.

### CROSS-REFERENCE TO RELATED APPLICATION

This application is a Section 111(a) application relating to and claiming the benefit of commonly-owned, co-pending U.S. Provisional Patent Application Ser. No. 62/433,466, filed Dec. 13, 2016, entitled, “BLIND BOLT FASTENER WITH EMBOSSED FEATURE FOR REACTING INSTALLATION TORQUE,” which is incorporated herein by reference in its entirety.

### FIELD OF THE INVENTION

The present application relates to fasteners and, more particularly, to blind bolt fasteners having embossed features that react installation torque.

### BACKGROUND OF THE INVENTION

Blind bolt fasteners are widely utilized on modern aircraft. The nature of the fastener design allows for one-sided installation which greatly improves the efficiency of fastener installation as only a single operator or robotic arm is required. Blind bolt fasteners can also be installed in areas where dual side access is not possible. Due to the desire for improved aerodynamics, electromagnetics, and paint adhesion properties, complete flushness may be desired on the installed structure's surface.

### SUMMARY OF THE INVENTION

In an embodiment, a fastener including a core bolt; and a sleeve adapted to receive the core bolt, the sleeve including an elongated portion having a first end and a second end opposite the first end, and a head located at the first end, the head including a first surface and a plurality of embossments located on and extending from the first surface. In an embodiment, the plurality of embossments is adapted to mate with and be engaged by corresponding debossments of a fastener installation tool. In an embodiment, the head of the sleeve includes a central opening formed within the first surface thereof and is sized and shaped to receive the core bolt, and the plurality of embossments is located circumferentially on the first surface and around the central opening. In an embodiment, the central opening includes a peripheral edge and the plurality of embossments are located proximate to the edge. In an embodiment, each of the plurality of embossments is arcuate in shape. In an embodiment, each of the plurality of embossments includes a first flat surface, a tapered surface that extends outwardly and away from a longitudinal axis of the fastener, and a pair of sidewalls, each of which extends from the flat surface to the tapered surface. In an embodiment, the plurality of embossments includes six of the embossments. In an embodiment, the plurality of embossments includes at least two of the embossments. In an embodiment, the plurality of embossments includes more than two of the embossments. In an embodiment, the fastener is a blind bolt fastener.

In an embodiment, the embossments work to react installation torque. In an embodiment, the embossments are adapted to be shaven or sanded off after the fastener has been installed in order to provide a smooth surface finish on the head of the sleeve.

### BRIEF DESCRIPTION OF THE DRAWINGS

FIG. 1 is a perspective view of an embodiment of a blind bolt fastener; and

FIG. 2A through 2C show steps of an installation sequence of the blind bolt fastener shown in FIG. 1.

### DETAILED DESCRIPTION OF THE DRAWINGS

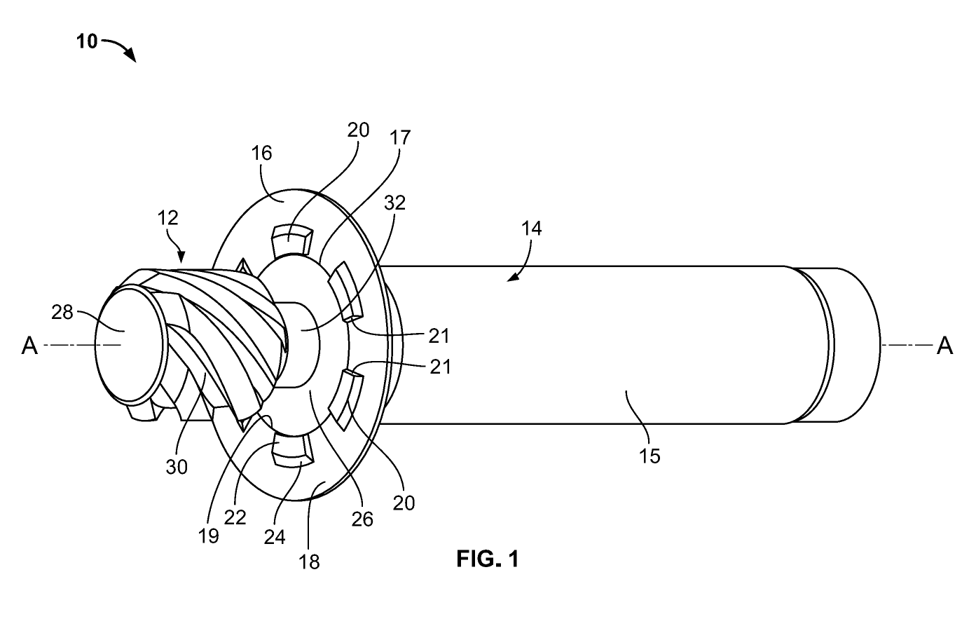

Referring to FIG. 1, in an embodiment, a fastener 10 is adapted to secure a plurality of workpieces to one another (not shown in the Figures). In an embodiment, the fastener 10 includes a core bolt 12 and a sleeve 14 that is sized and shaped and adapted to receive the core bolt 12. In an embodiment, the sleeve 14 includes an elongated portion 15 and a head 16 located at one end thereof. In an embodiment, the head 16 includes an outer, first surface 18 having a central opening 17 that is sized and shaped to receive the core bolt 12 and which leads into an interior area of the elongated portion 15. In an embodiment, the first surface 18 of the head 16 of the sleeve 14 includes an embossed anti-rotation feature to react installation torque. In an embodiment, the anti-rotation feature includes a plurality of embossments 20 that is positioned circumferentially on and extends from the first surface 18 of the head 16 of the sleeve 14 and around the central opening 17 of the sleeve 14. In an embodiment, each of the embossments 20 is arcuate in shape. In an embodiment, the embossments 20 are located proximate to a peripheral edge 19 of the central opening 17 of the sleeve 14. In other embodiments, each of the embossments 20 consists of other suitable shapes and sizes. In an embodiment, each of the embossments 20 includes a first flat surface 22 and a tapered surface 24 that extends outwardly and away from a longitudinal axis A-A of the fastener 10. In an embodiment, each of the embossments 20 include a pair of sidewalls 21 that extend from the flat surface 22 to the tapered surface 24 thereof. In an embodiment, the plurality of embossments 20 includes six of the embossments 20. In another embodiment, the plurality of embossments 20 includes at least two of the embossments 20. In another embodiment, the plurality of embossments 20 includes more than two of the embossments 20. In other embodiments, the plurality of embossments 20 includes more or less than the six embossments 20. In an embodiment, the embossments 20 are adapted to be engaged by mating debossed features positioned on one end of a fastener installation tool (not shown in the Figures). In an embodiment, the embossments 20 work to react installation torque, while the core bolt 12 is driven to form a fastener bulb (not shown in the Figures).

In an embodiment, the core bolt 12 includes an elongated shank having a first end and a second end opposite the first end, and which is sized and shaped to extend through the sleeve 14. In an embodiment, the sleeve 14 is sized and shaped to be inserted within openings of a plurality of workpieces (not shown in the Figures). In an embodiment, the shank of the core bolt includes a smooth portion and a threaded portion located at the second end of the shank. In an embodiment, the threaded portion of the shank includes a diameter that is less than a diameter of the smooth portion of the shank. In an embodiment, the core bolt 12 includes a first head 26 located at the first end of the shank and adjacent to the smooth portion. In an embodiment, the head 26 is frusto-conical in shape. In an embodiment, adjacent to the head 26 and also forming a portion of the core bolt 12 is a frangible, second head 28 having splines or threads 30 that are engageable by a suitable driver attached to an installation tool (not shown in the Figures). In an embodiment, the first and second heads 26, 28 are formed integrally. In an embodiment, between the first and second heads 26, 28 is a breakneck groove or portion 32 that defines the weakest point of the core bolt 12 and is adapted to fracture in torsional shear in response to the rotational force applied to second head 28 after the fastener 10 has been set, thereby providing the core bolt 12 with a flush configuration relative to the sleeve 14 after the fastener 10 has been set.

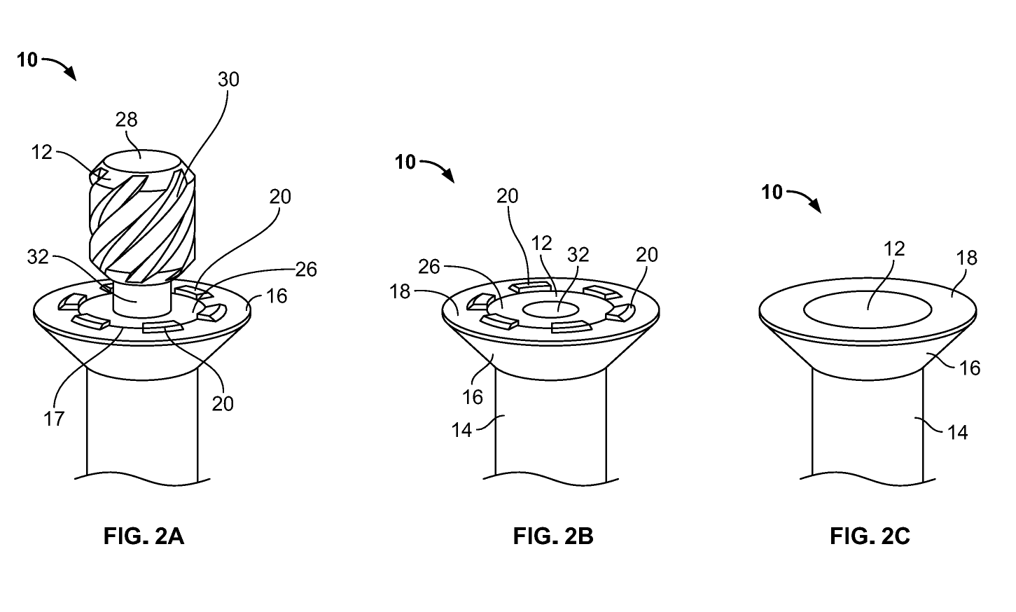

Referring to FIG. 2A, the fastener 10 is shown in a pre-installation phase. In an embodiment, a rotary installation tool having a nose assembly (not shown in the Figures) is provided to set the fastener 10. In an embodiment, the splines or threads 30 of the second head 28 of the core bolt 12 are engaged with complementary splines or threads of a driver of the tool (not shown in the Figures). As indicated above, the embossments 20 are adapted to be engaged by mating debossed features positioned on one end of the fastener installation tool. During installation, a torsional load builds up in the core bolt 12 and the break neck groove or portion 32 will fracture in torsional or rotational shear and the second head 28 will break off at the breakneck groove 32, as shown in FIG. 2B, and the first head 26 of the core bolt will be flush with the head 16 of the sleeve 14, and, particularly, the first surface 18 of the head 16. In another embodiment, when the second head 28 is broken off at the breakneck groove 32, the outer surface of the first head 26 of the core bolt 12 extends above relative to the first surface 18 of the head 16 of the sleeve 14.

Referring to FIG. 2C, in an embodiment, the embossments 20 are shaved or sanded down, as well as any remainder of the portion 32 of the core bolt 12, in order to provide a smooth surface finish on the first surface 18 of the head 16 of the sleeve 14 and the first head 26 of the core bolt 12.

In an embodiment, the fastener 10 is a blind bolt fastener. In other embodiments, the fastener 10 can consist of other suitable sleeved fasteners.

It should be understood that the embodiments described herein are merely exemplary and that a person skilled in the art may make many variations and modifications without departing from the spirit and scope of the invention. All such variations and modifications are intended to be included within the scope of the invention as exemplified by the appended claims.

What is claimed is:

1. A fastener, comprising:
a core bolt; and
a sleeve adapted to receive the core bolt, the sleeve including an elongated portion having a first end and a second end opposite the first end, and a head located at the first end, the head including a first surface and a plurality of embossments located on and extending from the first surface.

2. The fastener of claim 1, wherein the plurality of embossments is adapted to mate with and be engaged by corresponding debossments of a fastener installation tool.

3. The fastener of claim 1, wherein the head of the sleeve includes a central opening formed within the first surface thereof and is sized and shaped to receive the core bolt, and wherein the plurality of embossments is located circumferentially on the first surface and around the central opening.

4. The fastener of claim 3, wherein the central opening includes a peripheral edge and the plurality of embossments are located proximate to the edge.

5. The fastener of claim 4, wherein each of the plurality of embossments is arcuate in shape.

6. The fastener of claim 5, wherein each of the plurality of embossments includes a first flat surface, a tapered surface that extends outwardly and away from a longitudinal axis of the fastener, and a pair of sidewalls, each of which extends from the flat surface to the tapered surface.

7. The fastener of claim 3, wherein the plurality of embossments includes six of the embossments.

8. The fastener of claim 3, wherein the plurality of embossments includes at least two of the embossments.

9. The fastener of claim 3, wherein the plurality of embossments includes more than two of the embossments.

10. The fastener of claim 1, wherein the fastener is a blind bolt fastener.
